(19) United States
(12) Patent Application Publication
(10) Pub. No.: US 2008/0115570 A1
(43) Pub. Date: May 22, 2008

(54) Exhaust Gas Turbocharger

(76) Inventors: Johannes Ante, Regensburg (DE); Markus Gilch, Mauern (DE)

Correspondence Address: COHEN, PONTANI, LIEBERMAN & PAVANE, 551 FIFTH AVENUE, SUITE 1210, NEW YORK, NY, 10176, US

(21) Appl. No.: 11/666,524

(22) PCT Filed: Sep. 27, 2005
(86) PCT No.: PCT/EP05/54818

§ 371 Date: Apr. 27, 2007

(30) Foreign Application Priority Data
Oct. 29, 2004 (DE) 10 2004 052 695.8

(51) Int. Cl. F02B 33/44; G01M 15/04

(52) U.S. Cl. 73/114.77; 60/598

(57) ABSTRACT

An exhaust fume turbocharger for an internal combustion engine comprises a compressor and a turbine. A compressor wheel is rotatably mounted in the compressor and a turbine wheel is rotatably mounted in the turbine. The compressor wheel is mechanically connected to the turbine wheel by a rotatably mounted turboshaft. The compressor wheel is connected to the turboshaft by a fastening element and the exhaust fume turbocharger comprises a system for sensing the rotational speed of the turboshaft. The arrangement for sensing the rotational speed is arranged at the end of the turboshaft on the side of the compressor with an element for varying a magnetic field between the compressor wheel and the fastening element. The magnetic field is varied depending on the rotation of the turboshaft and a sensor element is arranged in the proximity of the element for varying the magnetic field for sensing the variation in the magnetic field and converting it into electrical signals.

The invention relates to an exhaust gas turbocharger for an internal combustion engine, with a compressor and a turbine, wherein a compressor wheel is rotatably mounted in the compressor and a turbine wheel is rotatably mounted in the turbine, and the compressor wheel is mechanically connected to the turbine wheel by means of a rotatably mounted turboshaft, wherein the turbine wheel is connected to the turboshaft by a fastening element, and wherein the exhaust gas turbocharger has a device for recording the speed of the turboshaft.

The power which is generated by an internal combustion engine depends upon the air mass and the corresponding fuel volume which can be made available to the engine for combustion. If it is desired to increase the power of the internal combustion engine, more combustion air and more fuel has to be supplied. This power increase in a naturally aspirated engine is achieved by means of an increase of the swept volume or by means of the increase of speed. An increase of the swept volume, however, basically leads to heavier internal combustion engines which are larger in dimensions and therefore more expensive. The increase of speed brings along with it significant problems and disadvantages, especially in the case of larger internal combustion engines, and is limited for technical reasons.

A much used technical solution for increasing the power of an internal combustion engine is boosting. By this is meant the precompression of the combustion air by means of an exhaust gas turbocharger, or also by means of a flow compressor which is mechanically driven by the engine. An exhaust gas turbocharger basically comprises a flow compressor and a turbine, which are connected to a common shaft and which rotate at the same speed. The turbine converts the normally uselessly explosive energy of the exhaust gas into rotational energy, and drives the flow compressor. The flow compressor, which in this connection is also referred to as a compressor, draws in fresh air and delivers the precompressed air to the individual cylinders of the engine. An increased fuel volume can be fed to the larger air volume in the cylinders, as a result of which the internal combustion engine delivers more power. The combustion process, moreover, is favorably influenced so that the internal combustion engine achieves a better overall efficiency. Furthermore, the torque characteristic of an internal combustion engine which is boosted by a turbocharger can be extremely favorably designed. With vehicle manufacturers, existing naturally aspirated production engines can be significantly optimized by the use of an exhaust gas turbocharger without great constructional interventions on the internal combustion engine. Boosted internal combustion engines as a rule have a lower specific fuel consumption and have a lower emission of pollutants. Furthermore, turboengines as a rule are quieter than naturally aspirated engines of the same power, since the exhaust gas turbocharger itself functions as an additional silencer. In the case of internal combustion engines with a large operating speed range, for example with internal combustion engines for private motor vehicles, a high charge pressure is stipulated even at low engine speeds. For this, a charge pressure control valve, a so-called waste-gate valve, is introduced in these turbochargers. By the selection of a corresponding turbine casing, a high charge pressure is quickly built up even at low engine speeds. The charge pressure control valve (waste-gate valve) then limits the charge pressure to a constant value during increasing engine speed.

Alternatively to this, turbochargers with variable turbine geometry (VTG) come into use. In the case of these turbochargers, the charge pressure is governed by the change of the turbine geometry.

With increasing exhaust gas volume, the maximum permissible speed of the combination which comprises the turbine wheel, the compressor wheel and the turboshaft, which combination is also referred to as the rotating components of the turbocharger, can be exceeded. With an impermissible exceeding of the speed of the rotating components these would be destroyed which amounts to a total loss of the turbocharger. Even modern and small turbochargers with appreciably smaller turbine wheel and compressor wheel diameters, which have an improved rotational acceleration performance on account of a significantly smaller mass inertia moment, are affected by the problem of exceeding the permissible highest speed. Depending upon design of the turbocharger, even an exceeding of the speed limit by about 5% leads to the complete destruction of the turbocharger.

The charge pressure control valves, which according to the prior art are controlled by a signal which results from the generated charge pressure, have proved their worth for speed limitation. If the charge pressure exceeds a predetermined threshold value, then the charge pressure control valve opens and some of the exhaust gas mass flow bypasses the turbine. This absorbs less power because of the reduced mass flow, and the compressor power reduces by the same measure. The charge pressure and the speed of the turbine wheel and of the compressor wheel are reduced. This control, however, is relatively sluggish, since the pressure build-up during an overspeed of the rotating components is carried out with a time lag. Therefore, the speed control for the turbocharger with charge pressure monitoring in the high-dynamic range (load change) has to be engaged by correspondingly early load pressure reduction which leads to a loss of efficiency.

A direct measuring of the speed on the compressor wheel or on the turbine wheel turns out to be difficult, since, for example, the turbine wheel is thermally extremely stressed (up to 1000° C.), which prevents a measuring of the speed by conventional methods on the turbine wheel. In a publication of acam-Mess-electronic GmbH of April 2001, it is proposed to measure the compressor blade impulse in the eddy current principle and in this way to determine the speed of the compressor wheel. This method is costly and expensive, since at least one eddy current sensor would have to be integrated in the casing of the compressor, which, on account of the high precision with which components of a turbocharger are manufactured, would be extremely difficult. In addition to the precise integration of the eddy current sensor in the compressor casing, sealing problems arise, which, on account of the high thermal stress of a turbocharger, are only to be overcome with costly interventions into the design of the turbocharger.

It is the object of the present invention, therefore, to disclose an exhaust gas turbocharger for an internal combustion engine, in which the speed of the rotating components (turbine wheel, compressor wheel, turboshaft) can be simply and inexpensively recorded and also without significant constructional interventions into the construction of existing turbochargers.

This object is achieved according to the invention by the device for recording the speed having an element for variation of a magnetic field on the end of the turboshaft on the compressor side, and by the element for variation of the magnetic field being located between the turbine wheel and the fastening element, wherein the variation of the magnetic field is carried out in dependence upon the rotation of the turboshaft, and wherein a sensor element is located in the proximity of the element for variation of the magnetic field, which sensor element records the variation of the magnetic field and converts the variation into electrically evaluatable signals.

In the arrangement of the element for variation of the magnetic field on the end of the turboshaft on the compressor side between the turbine wheel and the fastening element, it is advantageous that this region of the turbocharger is thermally relatively little stressed, since it lies a distance away from the hot exhaust gas flow and is cooled by the fresh air flow. Furthermore, the end of the turboshaft on the compressor side is easily accessible, as a result of which commercially available sensor elements, such as Hall sensor elements, magnetoresistive sensor elements or inductive sensor elements, can be located here without interventions, or with only minor interventions, into the design of the existing turbocharger, which enables an inexpensive measuring of speed in the turbocharger. By the signal which is generated by the sensor element, the charge pressure control valve can be very quickly and accurately controlled, or the turbine geometry of VTG chargers can be altered in order to avoid an overspeed of the rotating components. The turbocharger, therefore, can always be operated very close to its speed limit, as a result of which it achieves its maximum efficiency. A relatively large safety margin for the maximum speed limit, as is customary with pressure-controlled turbochargers, becomes unnecessary.

In a first development, the sensor element is formed as a Hall sensor element. Hall sensor elements are very well suited for recording the variation of a magnetic field, and, therefore, are very good to use for recording of speed. Hall sensor elements are very inexpensive commercially to purchase and they are usable even at temperatures up to about 160° C.

Alternatively to this, the sensor element is formed as a magnetoresistive (MR) sensor element. MR sensor elements for their part are well suited for recording the variation of a magnetic field and are inexpensively commercially purchasable.

In a next alternative development, the sensor element is formed as an inductive sensor element. Inductive sensor elements are also ideally suited for recording the variation of a magnetic field.

In a further development, the sensor element is located in the axial extension of the turboshaft. In this arrangement of the sensor element, the air flow in the air intake of the compressor is impeded to only a very small degree by the sensor element itself. As a result, the efficiency of the turbocharger is fully obtained.

Alternatively to this, the sensor element is located close to the end of the turboshaft on the compressor side. In this development, the variation of the magnetic field which is generated by a magnet which is located in the end of the turboshaft on the compressor side, can be recorded especially well, since, for example, the poles of a bar magnet can move past the sensor element one after the other.

In one development, the sensor element is integrated in a sensor which is formed as a plug-in finger probe which is pluggable into the air inlet by means of a recess in the compressor casing. Such a plug-in finger probe forms a very compact component which only slightly reduces the cross section of the air inlet. The installation of such a plug-in finger probe in a recess in the compressor casing proves to be very simple, which is especially a great advantage during the mounting process of the sensor element on the turbocharger.

According to a next alternative embodiment, the sensor element is integrated in a sensor which is seatable on the external wall of the compressor casing in the region of the air inlet. In this embodiment, no intervention whatsoever on the compressor casing or in the air inlet of the turbocharger has to be undertaken. The cross section of the air inlet is fully maintained and no undesired effects in the air flow upstream of the compressor wheel can be caused by the sensor element or the sensor. A powerful magnet, for example, which is located in the end of the turboshaft on the compressor side, generates a sufficiently sharp variation of the magnetic field in the sensor element, which is located on the external wall of the compressor casing, during rotation of the turboshaft, so that an electrical signal can be generated in the sensor which corresponds to the speed of the turboshaft.

In one development of the invention, the element for variation of the magnetic field is formed as a permanent magnet which is mounted in an enclosure. Such an enclosure prevents particles becoming detached from the magnet in the event of a possible break-up of the magnet and falling against the moving components of the turbocharger, which could lead to destruction of the turbocharger. Furthermore, a mass eccentricity on the turboshaft would result if particles were to become detached from the element for variation of the magnetic field. Such a mass eccentricity is effectively prevented by means of the enclosure.

Alternatively to this, the element for variation of a magnetic field is formed in the form of at least two magnetic dipoles which are mounted in the enclosure. Two magnetic dipoles fulfill the same function as a bar magnet, however they are lighter than a bar magnet, which is advantageous. A number of magnetic dipoles produce a high number of magnetic impulses, which is important if the position of the turboshaft is to be additionally recorded.

In one embodiment, the enclosure is formed as a cup-like constructional element. In a cup-like constructional element the magnets can be easily fitted in and/or glued in, which significantly simplifies the manufacture of the element for variation of the magnetic field. In this case, it is advantageous if the enclosure is formed from high-strength, low magnetic or non-magnetic metal.

In a further development, the element for variation of a magnetic field is formed as a bar magnet. A diametrally polarized bar magnet which rotates with the turboshaft generates an easily measurable variation of the magnetic field in its environment, by which the speed of the turboshaft, the compressor wheel and the turbine wheel is easily recordable.

Embodiments of the invention are exemplarily shown in the figures. In the figures:

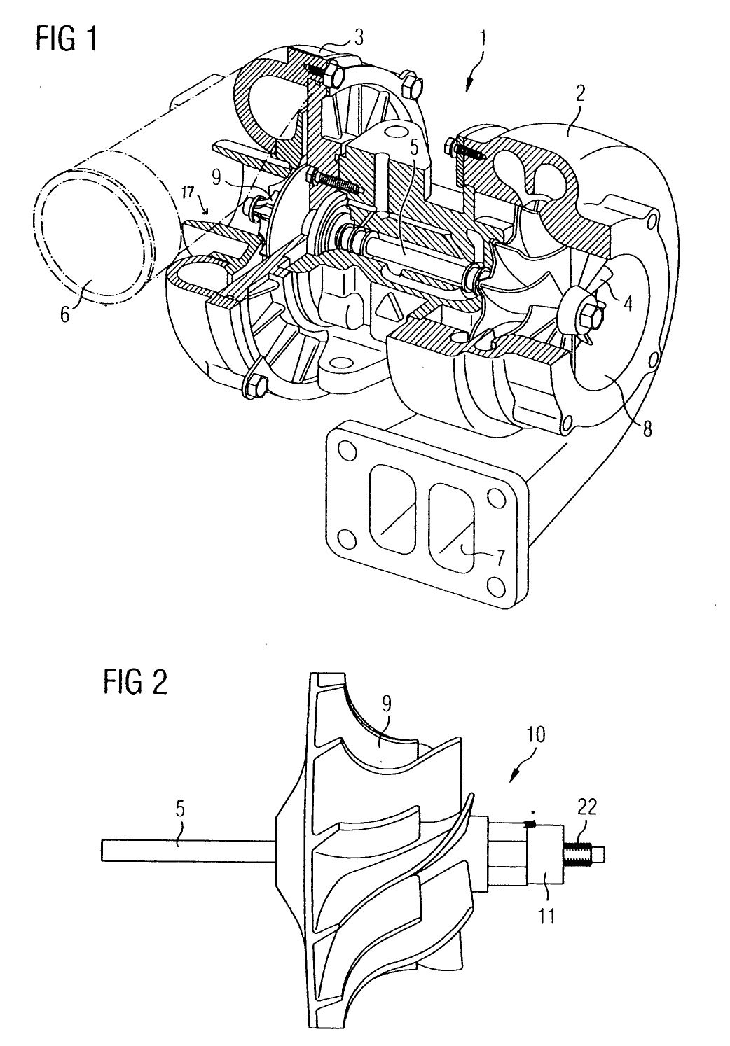

FIG. 1: shows a customary exhaust gas turbocharger,

FIG. 2: shows the turboshaft and the compressor wheel,

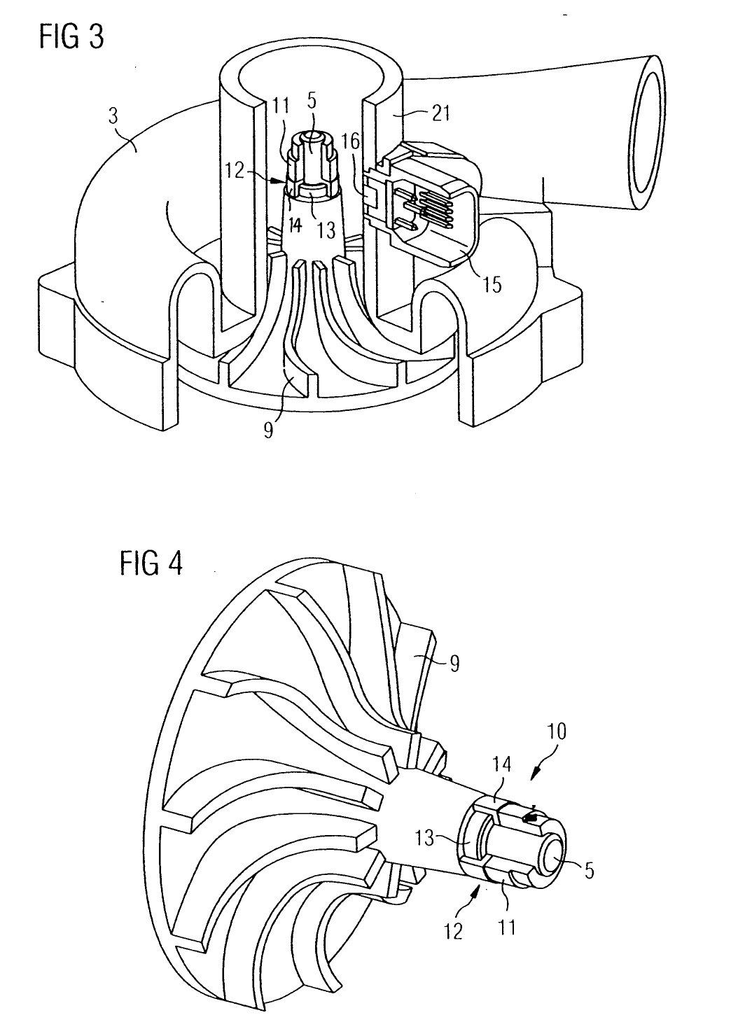

FIG. 3: shows the compressor in a partial section,

FIG. 4: shows the compressor wheel, with the turboshaft and the fastening element, which is known from FIG. 3

FIG. 5: shows the construction of the end of the turboshaft on the compressor side,

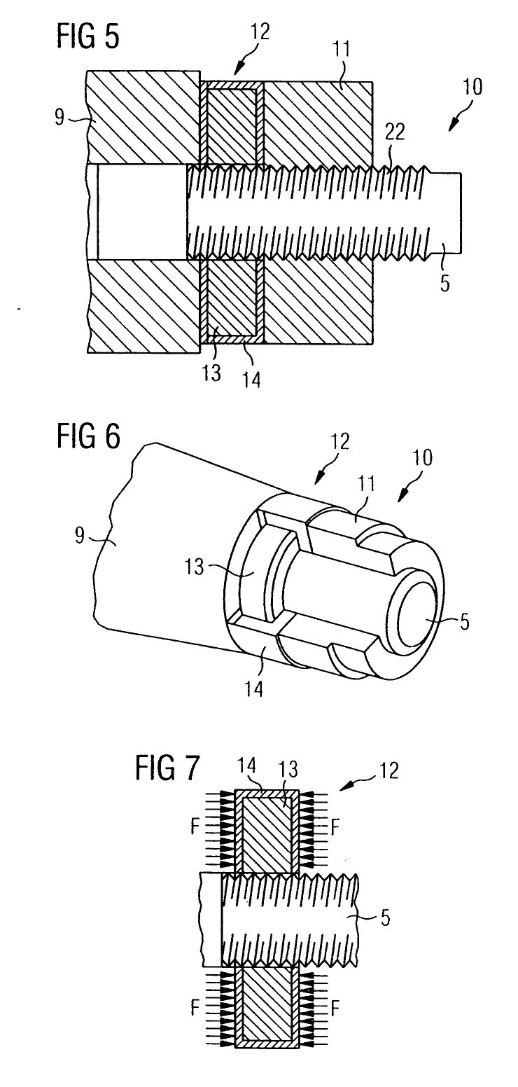

FIG. 6: shows the three-dimensional view of the arrangement from FIG. 5,

FIG. 7: shows the mechanical pressing forces which act upon the element for variation of the magnetic field,

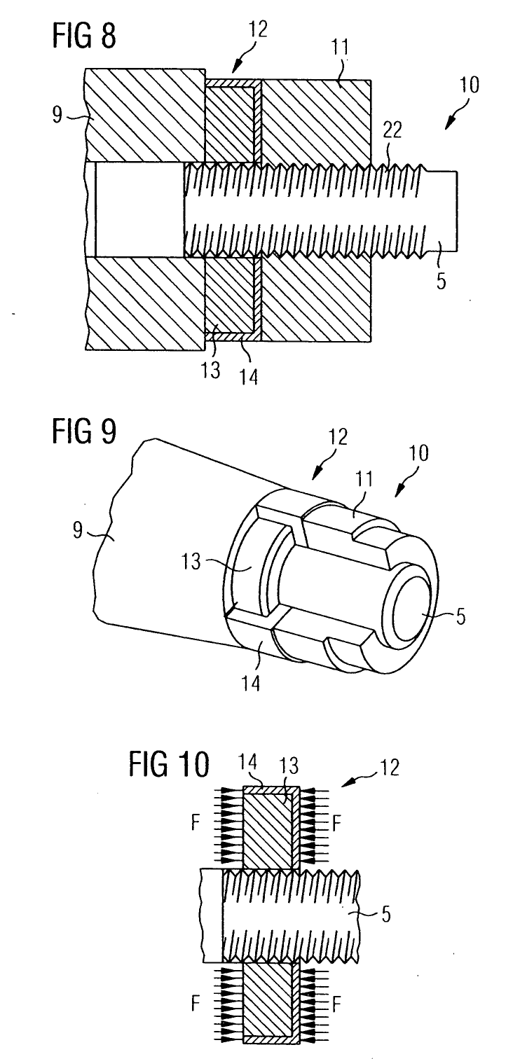

FIG. 8: shows a further possible embodiment of the enclosure,

FIG. 9: shows the perspective view of the arrangement on the end of the turboshaft on the compressor side,

FIG. 10: shows an embodiment of the enclosure,

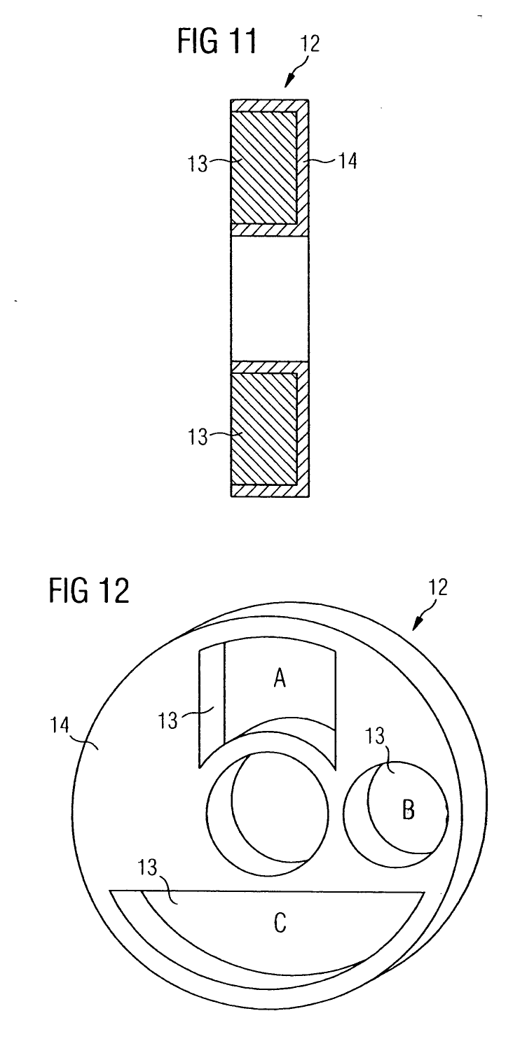

FIG. 11: shows a side sectioned view of the element for variation of the magnetic field,

FIG. 12: shows a plan view of the element for variation of the magnetic field,

FIG. 13: shows two D-form magnets, which are arranged in the enclosure,

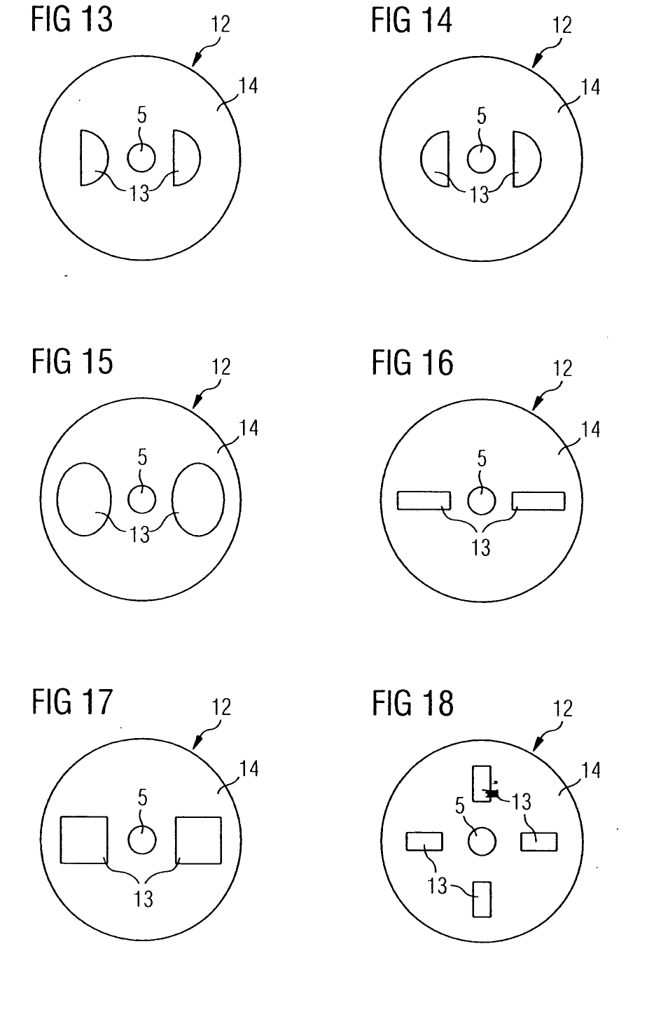

FIG. 14: shows another arrangement of the D-form magnets,

FIG. 15: shows the enclosure with two circular disk-form magnets,

FIG. 16: shows the enclosure with two bar-form magnets,

FIG. 17: shows the enclosure with two rectangular-form magnets,

FIG. 18: shows the enclosure with four bar-form magnets,

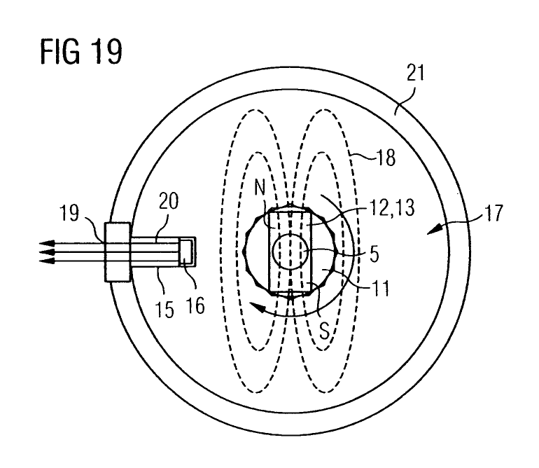

FIG. 19: shows the operating method of the element for variation of the magnetic field.

FIG. 1 shows a customary exhaust gas turbocharger 1 with a turbine 2 and a compressor 3. The compressor wheel 9 is rotatably mounted in the compressor 3 and connected to the turboshaft 5. The turboshaft 5 is also rotatably mounted and connected by its other end to the turbine wheel 4. Hot exhaust gas from an internal combustion engine, which is not shown here, is let into the turbine 2 via the turbine inlet 7, wherein the turbine wheel 4 is set in rotation. The exhaust gas flow leaves the turbine 2 through the turbine outlet 8. The turbine wheel 4 is connected to the compressor wheel 9 via the turboshaft 5. As a result, the turbine 2 drives the compressor 3. Air is drawn into the compressor 3 through the air inlet 17, is then compressed in the compressor 3, and is fed to the internal combustion engine via the air outlet 6.

FIG. 2 shows the turboshaft 5 and the compressor wheel 9. The compressor wheel 9, for example, is produced from an aluminum alloy in a precision casting process. The compressor wheel 9 is fastened as a rule on the end 10 of the turboshaft 5 on the compressor side by a fastening element 11. This fastening element 11, for example, can be a cap nut which with a sealing bush, a bearing collar and a distance sleeve tightly clamps the compressor wheel 9 against the turboshaft collar. For this purpose, a thread 22 is formed on the end 10 of the turboshaft 5 on the compressor side. Since the compressor wheel 9 as a rule comprises an aluminum alloy, no magnetic field variation can be measured on the compressor wheel 9 itself.

As a great advantage to the measuring of the speed of the turboshaft 5 on the end 10 of the turboshaft 5 on the compressor side, the prevailing temperature is to be mentioned here. Exhaust gas turbochargers 1 are thermally highly stressed components, in which temperatures up to 1000° C. occur. Measurements cannot be taken at these temperatures by known sensor elements 19, such as Hall sensors or magnetoresistive sensors. Significantly lower temperature stresses arise on the end 10 of the turboshaft 5 on the compressor side. As a rule, temperatures of about 140° C. in continuous operation and 160 to 170° C. after peak load occur in the air inlet 24 of a compressor 3. By means of the magnetic field sensor 14 which is located in the cold induction air flow, its temperature stress in comparison to the installation at other points of the exhaust gas turbocharger is substantially reduced.

FIG. 3 shows the compressor 3 in a partial section. The compressor wheel 9 is to be seen in the cut-away compressor casing 21 of the compressor 3. The compressor wheel 9 is fastened on the turboshaft 5 by the fastening element 11. The fastening element 11, for example, can be a cap nut which is screwed onto a thread which is applied on the turboshaft 5 in order to clamp the compressor wheel 9 against a collar of the turboshaft 5 by this. The element 12 for variation of the magnetic field is located between the fastening element 11 and the compressor wheel 9. In this case, the element 12 for variation of the magnetic field is assembled from a magnet 13 and an enclosure 14, which is shown in still more detail in FIG. 4. The element 12 for variation of the magnetic field is pressed against the compressor wheel 9 by means of the fastening element 11, and during rotation of the turboshaft 5, the element 12 for variation of the magnetic field rotates around the rotational axis of the turboshaft 5. In this case, the element 12 for variation of the magnetic field produces a change of the magnetic field strength or the magnetic field gradient, as the case may be, in the sensor element 16. The sensor element 16 is integrated in the sensor 15, and in this example is located in a recess of the compressor casing 21. The variation of the magnetic field or the field gradient, as the case may be, in the sensor element 16, produces in the latter an electronically processible signal which is proportional to the speed of the turboshaft 5. Since the described arrangement is located on the compressor side, and, therefore, on the comparatively cold end 10 of the turboshaft 5, sensor elements 16 can be used which are inexpensively and commercially obtainable. On account of the relatively low temperature stress on the end 10 of the turboshaft 5 on the compressor side during operation of the turbocharger, no exceptionally high demands have to be made on the sensor elements 16 with regard to their temperature stability.

FIG. 4 shows the compressor wheel 9 which is known from FIG. 3, with the turboshaft 5 and the fastening element 11. It is to be clearly seen here that the fastening element 11 presses the element 12 for variation of the magnetic field against the compressor wheel 9. The element 12 for variation of the magnetic field is assembled from a magnet 13 which is mounted in an enclosure 14. Permanent magnets 13, which generate a relatively high field strength, as a rule are made of a very brittle material. Examples of such magnet materials are rare earths or samarium-cobalt mixtures. At high speeds of the turboshaft 5 of up to 300,000 revolutions per minute these brittle magnets 13 can break up because of the high centrifugal forces, wherein fractured pieces of the magnet 13 separate and are thrown out from the latter, and wherein the fractured pieces become a hazard for the moving components of the turbocharger 1. In order to prevent this, the magnet 13 is accommodated in an enclosure 14 which, for example, comprises high-strength steel which does not impair the magnetic properties of the magnet 13 but mechanically supports the magnet 13 to a point where the latter cannot split up and/or no fractured pieces of the magnet 13 can be thrown out from this, which would then uncontrollably get into the air inlet 17 of the turbocharger 1.

FIG. 5 schematically shows the construction of the end 10 of the turboshaft 5 on the compressor side. A thread 22 is formed on the turboshaft 5, upon which is screwed the fastening element 11 which is formed as a nut. Furthermore, a part of the compressor wheel 9 is to be seen upon which the element 12 for variation of the magnetic field is pressed by means of the fastening element 11. The element 12 for variation of the magnetic field comprises a cup-like enclosure 14 in which the magnet 13 is mounted. This enclosure 14 can be manufactured, for example, from a high-strength steel.

The arrangement which is shown in FIG. 5 is once again shown three-dimensionally in FIG. 6. The turboshaft 5 is again to be seen, upon which the fastening element 11 is screwed from the end 10 of the turboshaft 5 on the compressor side. The fastening element 11 presses the element 12 for variation of the magnetic field against the compressor wheel 9, which is only partially shown. The element 12 for variation of the magnetic field, which is shown in a cut-away view here, comprises the magnet 13 and the enclosure 14.

In FIG. 7, the forces F are shown which are exerted by means of the fastening element 11 on the element 12 for variation of the magnetic field. These forces F are easily absorbed by the brittle material of the magnet 13 without acting destructively upon this. The centrifugal forces which arise during rotation of the turboshaft 5, are absorbed by the enclosure 14. In the case of a structural breakage of the magnet 13, the cup-like structure holds together fractured pieces which possibly arise without imbalances being created or particles splitting off and being able to freely get into the turbocharger 1.

FIG. 8 shows a further possible embodiment of the enclosure 14. The compressor wheel 9 is to be seen here also, against which the element 12 for variation of the magnetic field is pressed by the fastening element 11. This pressure again is effected by the fastening element 11 being formed as a nut which is screwed onto the thread 22 which is provided on the end 10 of the turboshaft 5 on the compressor side.

FIG. 9, similarly to FIG. 6, shows the perspective view of the arrangement on the end 10 of the turboshaft 5 on the compressor side.

As is to be seen in FIG. 10, the enclosure 14 here is formed L-shaped in cross section, which is entirely adequate to absorb the high centrifugal forces which arise during rotation of the turboshaft 5 and which are exerted by the magnet 13 on the enclosure 14. Again, the forces F are drawn in, which both by means of the fastening element 11 and by means of the compressor wheel 9 act upon the element 12 for variation of the magnetic field. These forces F are easily tolerated by the magnet 13 without it leading to damage on the magnet 13.

FIG. 11 shows a side sectioned view of the element 12 for variation of the magnetic field. The element 12 for variation of the magnetic field comprises the enclosure 14 and the magnet 13. The enclosure 14 as a rule is manufactured from a high-strength metal and absorbs the centrifugal forces which emanate from the magnet 13 during rotation of the turboshaft. The magnet 13, therefore, is held together by means of the enclosure 14, and a brittle material can be selected for the permanent magnet 13, which material generates relatively high magnetic field strengths.

FIG. 12 shows a plan view of the element 12 for variation of the magnetic field. The enclosure 14 in this example has a first region A, a second region B, and a third region C. A magnet 13, or a combination of magnets, can be arranged in each of these regions A, B, C. Examples of this are shown in FIGS. 13 to 18.

FIG. 13 shows two D-form magnets 13 which are arranged in the enclosure 14.

FIG. 14 also shows two D-form magnets 13, wherein, however, unlike FIG. 13, a magnet is rotated in relation to its position in FIG. 13.

FIG. 15 shows the element 12 for variation of the magnetic field with the enclosure 14 in which two circular disk-form magnets 13 are arranged.

FIG. 16 shows the element 12 for variation of the magnetic field which comprises the enclosure 14 and two bar-form magnets 13.

FIG. 17 shows the element 12 for variation of the magnetic field, wherein two rectangular-form magnets 13 are arranged in the enclosure 14.

Finally, FIG. 18 shows the element 12 for variation of the magnetic field, wherein four bar-form magnets 13 are arranged in the enclosure 14.

FIG. 19 shows in more detail the operating method of the element 12 for variation of the magnetic field. The bar magnet 13 which is located in the enclosure 14 here has a North pole N and a South pole S. The magnetic field 18 which is shown is produced by this. During rotation of the turboshaft 5, the magnetic field 18 also co-rotates, wherein both the magnetic field strength and the gradient of the magnetic field in the sensor element 16 is varied. The sensor 15 which is shown here is formed as a plug-in finger probe 20 and by means of a recess in the compressor casing 21 is located in the proximity of the element 12 for variation of the magnetic field 18. The term “in the proximity” in this connection means that the change of the magnetic field strength or of the magnetic field gradient, as the case may be, which is generated by the element 12 for variation of the magnetic field 18 is sufficient to generate easily measurable electronic signals in the sensor element 16. Electronic signals which noticeably stand out from electronic noises of the system are referred to as “easily measurable” in this connection. The electronic signals which are generated in the sensor 15 are made available via electrical connections of the vehicle's electronics, especially the engine management, in order to prevent an exceeding of the speed limit of the turbocharger 1, but on the other hand to always rotate the turbocharger up to its speed limit as far as possible to obtain the full power of the turbocharger.

1.-10. (canceled)

14. An exhaust gas turbocharger for an internal combustion engine, comprising:
a compressor having a rotatably mounted compressor wheel;
a turbine having a rotatably mounted turbine wheel;
a rotatably mounted turbo shaft mechanically connecting the turbine wheel to the compressor wheel, the turboshaft having a turbine side end and a compressor side end;
a fastening element connecting the compressor wheel to the compressor side end of the turboshaft; and
a device for recording a speed of the turboshaft having a first element for varying a magnetic field arranged on the compressor side end of the turboshaft between the compressor wheel and the fastening element, the first element varying the magnetic field in dependence on a rotation of the turboshaft, and a sensor element located proximate the first element, the sensor element recording the variation of the magnetic field and converting the variation into electrically evaluatable signals indicating the speed of the turboshaft, wherein the sensor element is one of a Hall sensor element or a magnetoresistive sensor element.

15. The exhaust gas turbocharger of claim 14, wherein the sensor element is located in an area of an axial extension of the turboshaft.

16. The exhaust gas turbocharger of claim 14, wherein the sensor element is located proximate the compressor side end of the turboshaft.

17. The exhaust gas turbocharger of claim 14, wherein the compressor has a compressor casing with an air inlet, the sensor element being integrated in a sensor formed as a plug-in finger probe pluggable into a recess in the air inlet of the compressor casing.

18. The exhaust gas turbocharger of claim 14, wherein the compressor has a compressor casing with an air inlet, the sensor element being integrated in a sensor seatable on an external wall of the compressor casing in a region of the air inlet.

19. The exhaust gas turbocharger of claim 14, wherein the first element includes an enclosure and a permanent magnet mounted in the enclosure.

20. The exhaust gas turbocharger of claim 19, wherein the first element includes at least two magnetic dipoles.

21. The exhaust gas turbocharger of claim 19, wherein the enclosure has cup-shaped cross-section.

22. The exhaust gas turbocharger of claim 19, wherein the enclosure is formed from a high strength material comprising one of a low-magnetic or non-magnetic metal.

23. The exhaust gas turbocharger of claim 19, wherein the first element is a bar magnet.

24. The exhaust gas turbocharger of claim 14, wherein the first element includes at least two magnetic dipoles.

25. The exhaust gas turbocharger of claim 14, wherein the first element is a bar magnet.

26. The exhaust gas turbocharger of claim 20, wherein the enclosure has a cup-shaped cross-section.

27. The exhaust gas turbocharger of claim 19, wherein the enclosure has an L-shaped cross-section.

28. The exhaust gas turbocharger of claim 19, wherein the enclosure radially encloses the permanent magnet.
